(19) United States
(12) Patent Application Publication
(10) Pub. No.: US 2009/0072026 A1
(43) Pub. Date: Mar. 19, 2009

(54) CONCEPT CARD AND SELLING SYSTEM AND METHOD BASED ON PURCHASER USING THE CARD

(76) Inventors: Kil-Jin Lee, Seoul (KR); Young-Mi Lee, Seoul (KR)

Correspondence Address: IPLA P.A., 3580 WILSHIRE BLVD., 17TH FLOOR, LOS ANGELES, CA, 90010, US

(21) Appl. No.: 12/282,422

(22) PCT Filed: Apr. 17, 2007
(86) PCT No.: PCT/KR2007/001859

§ 371 Date: Sep. 10, 2008

(30) Foreign Application Priority Data
Apr. 25, 2006 (KR) 10-2006-0036966

(51) Int. Cl. G06F 19/00

(52) U.S. Cl. 235/380

(57) ABSTRACT

A new concept card and a selling system and method based on a purchaser using the card are disclosed. The system includes a card system 4 which issues a new concept card for allowing a card company to identify a seller or registers or grants information to a seller, a seller system 3 or terminal 31 which allows the seller to receive the UC or information and to advertise the card or information to a purchaser and allows the purchaser to purchase merchandise, a purchaser terminal 1 which allows the purchaser to access the seller system or terminal so as to purchase merchandise or acquire the UC information and to access the card company to rapidly/accurately input the UC or seller information such that credit card approval is requested, and a bank system 2 which processes the credit car approval when the purchaser requests the credit card approval.

### TECHNICAL FIELD

The present invention relates to a new concept card and a selling (marketing) system and method based on a purchaser using the card, and more particularly, to a new concept card which allows a seller to advertise a card having seller information recorded therein to a purchaser upon an on- or off-line commercial transaction and allows the purchaser to conveniently input the seller information using the new concept card upon all commercial transactions including the purchase of merchandise (including a service) so as to realize rapid/accurate commercial transaction and a selling (marketing) system and method based on a purchaser using the card.

### BACKGROUND ART

Now, in on- or off-line selling, since a seller sells merchandise (including a service) through a variety of media from the viewpoint of the seller, the seller collects a general advertisement such as merchandise/price/shop information and customer information such as member joining without providing seller information and randomly manages/sells merchandise without the member joining. In addition, in the payment of a purchaser, transaction is accomplished by paying in cash or providing credit card information to the seller.

However, in such a selling method, when a customer holds cash, there is inconvenience or cash-loss hazard due to the holding of cash. In addition, a seller must have a card approval terminal such that a purchaser makes payment using a credit card. Since credit card information is provided to the seller, information on a purchaser is apt to be leaked due to the duplication, forgery, or double approval of the card. Therefore, a variety of accidents may be caused and security is weak. A purchaser always feels inconvenience or insecurity in usage, and payment except for payment in cash is hardly made in a place where a credit card approval terminal is not provided unlike the Internet or a shop. In particular, when a purchaser does not hold cash at night, the purchaser feels inconvenience in payment.

In view of a seller, growth in sales is unlikely to be achieved due to the restriction of a customer's purchasing activity, and an accident may be caused due to non-payment. In addition, it is difficult for a seller to manage cash including small change in a large shop.

### DISCLOSURE OF INVENTION

### Technical Problem

Therefore, the present invention has been made in view of the above problems, and it is an object of the present invention to provide a system which includes a card company (bank) system which issues a new concept card (Ubiquitous card (UC)) for allowing a card company (bank) to identify a seller or registers or grants information to a seller, a seller system or terminal which allows the seller to receive the UC or information and to advertise the card or information to a purchaser and allows the purchaser to purchase merchandise, a purchaser terminal which allows the purchaser to access the seller system or terminal so as to purchase merchandise or acquire the UC information and to access the card company (bank) to rapidly/accurately input the UC or seller information such that credit card approval is requested, and a card company (bank) and bank system which process the credit car approval when the purchaser requests the credit card approval, all of which are connected in wired/wireless communication lines such that the seller can sell merchandise using a credit card regardless of whether a credit card approval terminal is mounted to expand the customer base with an active advertisement using the UC and the purchaser can rapidly/accurately input the UC information of the seller and the credit card approval information using the UC information so as to realize stable convenient commercial transaction, and a method which can activate a purchase activity and increase selling efficiency by simultaneously satisfying the desires of the seller and the purchaser.

### Technical Solution

In accordance with an aspect of the present invention, the above and other objects can be accomplished by the provision of a selling system based on a purchaser using a new concept card, the system comprising: a purchaser terminal which includes a function for accessing the Internet through a wired/wireless communication line and a function for accessing a seller server over the Internet, acquiring Ubiquitous card (UC) information, and purchasing merchandise, accesses a server of a card company (bank) to perform a credit card approval process after purchasing the merchandise, and accesses a bank system to perform a process relating a bank account; a card system which registers, grants and issues UC information of a seller, identifies the purchaser, receives the UC information, credit card information, a purchase number and a price and performs the credit card approval process when the purchaser requests credit card approval, notifies the bank system of credit card approval contents of the purchaser to request transfer of money, stores card member information, the UC information of the purchaser and the seller, transaction information of the purchaser, and credit card approval information in a database (DB), and notifies the purchaser terminal and a seller system or a seller terminal of the card member information, the UC information of the purchaser and the seller, the transaction information of the purchaser, and the credit card approval information; the bank system which stores card account information of the purchaser and the seller, manages the accounts by the purchaser terminal and the seller system or the seller terminal, and transfers money from the card account of the purchaser to the card account of the seller when the card system requests the processing of the credit card approval contents; and the seller system which accesses a card company (bank) system over the Internet so as to register, grant, and issue the UC information, accesses the bank system to manage bank account information, provides information such that the purchaser can acquire the UC information and search and purchase the merchandise over the Internet, and includes a seller manager server for transmitting an order number and a price necessary for the credit card approval at the time of purchasing the merchandise and a seller terminal for connecting the seller to a card company (or the bank) or the purchaser.

In accordance with another aspect of the present invention, there is provided a selling method based on a purchaser using a new concept card, the method comprising: a first step of allowing a seller to enter into a affiliation contract using a seller terminal or through a visit to a card company, registering and granting a Ubiquitous card (UC) information, and issuing an UC; a second step of allowing the seller to access a card company or a bank through a seller management server so as to register or grant the UC information and issue the UC, to access a bank system to manage bank account information, to access a purchaser terminal to perform a purchase process of the purchaser, and to notify the purchaser of information including the UC or all software and a module of the UC; a third step of registering registration information of the UC of the seller obtained by the first and second steps in a database (DB) of the card company; a fourth step of allowing the purchaser to access a seller system or the seller terminal using a purchaser terminal to receive the UC information, to have a consultation about the purchase of merchandise and to purchase the merchandise and allowing the seller to notify the purchaser terminal of requirements such as an order number and a price when the consultation about the purchase of the merchandise is completed; a fifth step of allowing the purchaser to access the card company's ARS system and the card company's web server using the purchaser terminal to input credit card approval information such as the order number and the price or contact the UC so as to request credit card approval and to access the bank system to perform a process relating to a bank account, after the fourth step; and a sixth step of allowing the card company's ARS system or the card company's web server to identify the purchaser through a predetermined authorization process while transmitting the credit card approval information inputted by the purchaser, and allowing the card company server to request transfer of money from a card account of the purchaser to a card account of the seller by the bank system after the authorization process; and a seventh step of accessing the purchaser and the seller to process account management contents or accessing the card company or the bank to process credit card approval contents of the purchaser, which is requested by the card company.

In accordance with another aspect of the present invention, there is provided a selling system based on a purchaser using a new concept card which is registered or granted to a seller or an affiliated shop for registering related information in a card company or a bank, wherein basic information of the affiliated shop, such as a national code, a card identification code, an organ code, an affiliation year, a serial number, a verification number, and a company's serial number, a seller's name, a tax number, and a telephone number, a card number, and an inherent identification number are recorded in a form of numerals, characters, a barcode, and an electronic tag, and the card is in any one of a cash card form, a sticker form, a simple paper form, a terminal form, a system form, or an electronic tag form, which is used for identifying the seller affiliated with the card company or the bank.

### ADVANTAGEOUS EFFECTS

According to the present invention, a purchaser who holds a credit card can rapidly/accurately input information recognized using the new concept card of a seller or contact the new concept card to realize transaction according to credit card approval without giving the credit card, regardless of the non-holding of cash, time, a place, the credit card approval, and the non-holding of a terminal. Therefore, the purchaser can conveniently use the card and thus number of customers can increase to accomplish growth in sales. In addition, in on- or off-line commercial transaction, stable efficient payment can be made while the exposure of purchaser information is minimized. Furthermore, illegal use of a customer's credit card and conflict between a purchaser and a seller can be prevented.

### DESCRIPTION OF DRAWINGS

The above and other objects, features and other advantages of the present invention will be more clearly understood from the following detailed description taken in conjunction with the accompanying drawings, in which:

FIG. 1 is a block diagram showing an embodiment of the present invention;

FIG. 2 is a flowchart illustrating a method of allowing a seller to request a card company to issue a new concept card and allowing the seller to provide and advertise the card to a purchaser; and

FIG. 3 is a flowchart illustrating a method of performing a credit card approval process using the new concept card when a purchaser purchases merchandise according to the embodiment of the present invention.

### BEST MODE

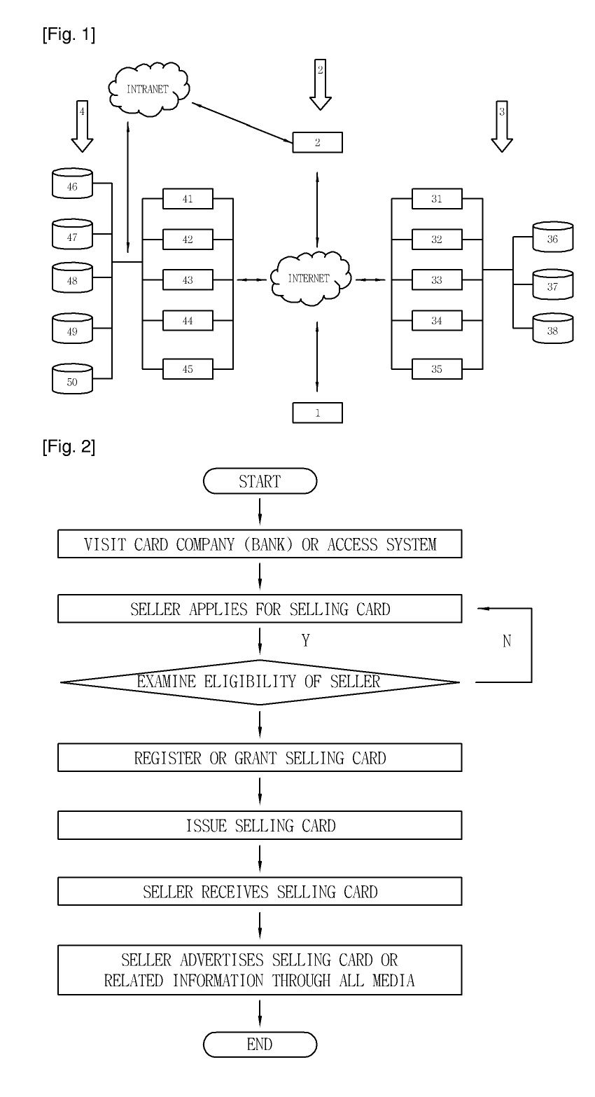

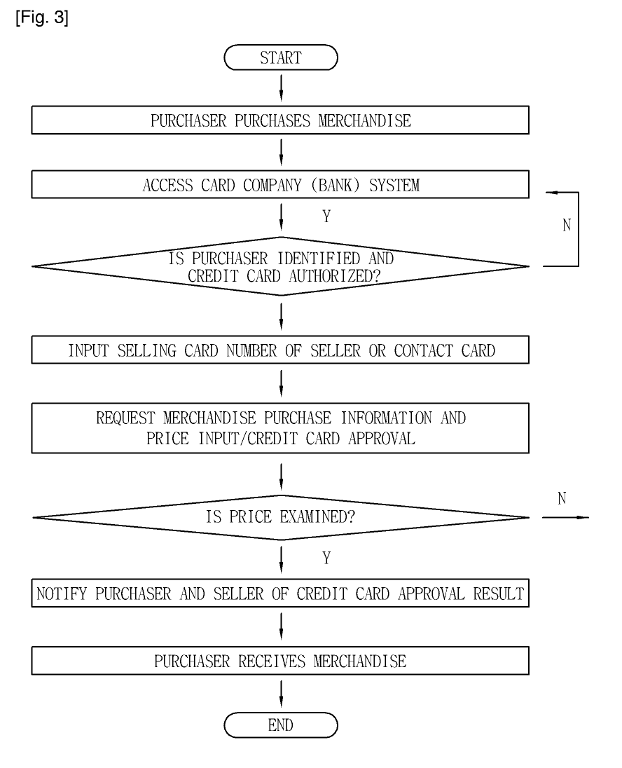

Hereinafter, a selling (marketing) system and method according to a preferred embodiment of the present invention will be described with reference to FIGS. 1 to 3.

FIGS. 1 to 3 show an embodiment of the present invention.

A system according to the embodiment of the present invention includes:

a purchaser terminal 1 which includes a function for accessing the Internet through a wired/wireless communication line, and allows a purchaser to access a seller server through the Internet so as to purchase merchandise and to access a card company (bank) server to perform a credit card approval process;

a card system 4 which registers, grants and issues Ubiquitous card (UC) information of a seller, requests a bank system to process approval contents using the credit card of the purchaser, and stores card member information, UC information of the purchaser and the seller, transaction information of the purchaser, and payment information in a database (DB);

the bank system 2 which stores card accounts of the purchaser and the seller and transfers money from the card account of the purchaser to the card account of the seller when the card system 4 requests the processing of the credit card approval contents; and

a seller system 3 which accesses a card company (bank) system over the Internet so as to register, grant, and issue the information of the seller, provides information such that the purchaser searches and purchases merchandise, and includes a seller manager server 32 for transmitting an UC card number, an order number, and a price necessary for the credit card approval at the time of purchasing the merchandise and a seller terminal 31 for connecting the seller to the card company or the purchaser.

The card system 4 includes a card company server 41 which controls the registration and grant of the UC of the seller and the transfer of money from the card account of the purchaser to the card account of the seller, a card company's web server 42 which provides approval information to the card company server 41 to transfer money when the purchaser requests credit card approval over the Internet, a card company's ARS system 44 which transmits a guide message such that the purchaser who accesses the card company server by a telephone can input transaction information, and transmits credit card approval information inputted by the purchaser to the card company server 41 such that the credit card approval is accomplished, a card company's mail server 43 which transmits information as to whether the credit card approval is accomplished to the purchaser terminal 1 and the seller terminal 31, a card customer information DB 46 which stores the UC information of the seller having the issued card, a card company's purchaser/seller information DB 47 which stores card information of the purchaser and seller having registered cards, a card company's purchaser transaction information DB 48 which stores entire transaction information of the purchaser, a card company's transaction authorization DB 49 which stores authorization information used for identifying the purchaser when requesting for the credit card approval of the purchaser, and a card company' pre-approval DB 50 which processes credit card pre-approval contents of the purchaser when requesting for pre-approval of the purchaser.

The selling (marketing) method implemented by the selling (marketing) system having the above-described configuration includes:

a first step of allowing a purchaser to enter into a affiliation contract using the seller terminal 31 or through a visit to a card company and registering UC information and issuing an UC;

a second step of registering the UC information of the seller obtained by the first step in the DB of the card company;

a third step of allowing a purchaser to access the seller system 3 using the purchaser terminal 1 to have a consultation about the purchase of merchandise and to purchase the merchandise and allows the seller to notify the purchaser of requirements such as the UC information, an order number, and a price when the consultation about the purchase of the merchandise is completed;

a fourth step of allowing the purchaser to access the card company's ARS system 44 and the card company web server 42 and to input credit card approval information such as the order number, the price, the UC information or contact the UC so as to request credit card approval, after the third step; and

a fifth step of allowing the card company's ARS system 44 or the card company's web server 42 to identify the purchaser through a predetermined authorization process while transmitting payment information inputted by the purchaser and allowing the card company server 41 to request the transfer of money from the card account of the purchaser to the card account of the seller using the credit card approved by the bank system 2 after the authorization process.

The card company's mail server 43 notifies the purchaser terminal 1 and the seller system 3 or terminal of the result of the credit card approval. The card company sever 41 stores the result of transferring money in the DB such that the seller accesses the card company's web server 42 or the card company's ARS system 44 using the seller terminal to check which the credit card approval or the transfer of money is accomplished.

In the fifth step, the card company server 41 processes credit card pre-approval in the card company's pre-approval DB 50 when the credit card pre-approval of the purchaser occurs in the fifth step, and processes the credit card approval in the card company's transaction authorization DB 49 when the purchased merchandise is delivered and main approval of the purchaser occurs, and requests the bank system 2 to process credit card approval contents.

The UC is a card which is registered or granted to a seller (affiliated shop) by the card company (or the bank for performing a credit card job) and has seller information recorded therein. The UC has basic information of the affiliated shop, such as a national code, a card identification code, an organ code, an affiliation year, a serial number, a verification number, and a company's serial number, and a card number (inherent identification number) recorded thereon and is in any one of a conventional credit card form, a cash card form, a sticker form, a simple paper form, a terminal form, a system form, or an electronic tag form, which is used for identifying a seller affiliated with the card company (or the bank).

Hereinafter, the selling (marketing) method according to the embodiment of the present invention will be described.

A seller accesses the card company's web server 42 over the Internet or the card company's ARS system 44 of the card company system 4 using his/her terminal 31 or visits to a branch of the card company such that an UC is issued or an UC number is received. The card company server 41 stores personal information and UC information of the seller in the DBs 46 to 50, notifies the seller of registration information of the UC card upon the access through the terminal 31.

When a purchaser accesses a seller management server 32 of the seller system 3 using his/her terminal 1 in a state that the UC is issued from the card company (or the bank) to the seller, the seller management server 32 provides or advertises the UC information or transmits merchandise information stored in a merchandise DB 36 to the purchaser terminal 1 such that the purchaser purchases desired merchandise.

When purchasing the merchandise, the purchaser can purchase the merchandise through the seller management server 32 or purchase the merchandise or consults with the seller about the merchandise by a telephone.

When the purchase of the merchandise is realized, the seller notifies the purchaser of the UC information, an order number and a price and the purchaser accesses the card company's web server 42 or the card company's ARS system 44 using the purchaser terminal 1 and requests credit card approval by inputting the UC information, the order number, and the price received from the seller.

The credit card approval information inputted by the purchaser is transmitted to the card company server 41 through the card company's web server 42 or the card company's ARS system 44. At this time, the card company's web server 42 and the card company's ARS system 44 identifies the purchaser using a variety of authorization information such as an encryption/security card/electronic certificate, and the card company server 41 processes the credit card approval of the purchaser and requests the bank system 2 to process credit card approval contents when the authorization process is completed.

The bank system 2 processes the credit card approval contents of the purchaser according to the request of the card company server 41 and notifies the card company server 41 of the processed result. The card company server 41 stores the processed result in the card company's purchaser transaction information DB 48.

The card company server 41 notifies the purchaser terminal 1 or the seller system 3 or the seller terminal 31 of the credit card approval process such that the purchaser checks whether the process is normally performed, and stores approval information in the DB such that the seller accesses the card company's web server 42 or the card company's ARS system 44 using the seller terminal 31 to check whether the credit card approval is processed.

Meanwhile, in the present invention, a purchaser may request the credit card pre-approval.

That is, when the purchaser requests pre-approval while inputting the approval information, the card company server 41 processes the pre-approval in the card company's pre-approval DB 50 and performs a process of approving the pre-approved contents stored in the pre-approval DB when the merchandise is normally delivered from the seller to the purchaser and the purchaser requests main approval.

When the pre-approval method is used, the real approval is realized after the merchandise is delivered from the seller to the purchaser. Thus, in commercial transaction, the damage of the purchaser can be prevented. If the purchaser confirms that the merchandise is not normally delivered from the seller or the merchandise is bad and cancels the order, the contents of the pre-approval DB are cancelled.

The selling (marketing) system according to the present invention is efficiently used in off-line commercial transaction as well as on-line commercial transaction.

For example, when a purchaser refuels his/her car at a filling station, the filling station notifies the purchaser of information necessary for credit card approval such as an order number, an UC number, a purchase number, and a price. When the purchaser performs a credit card approval process using his/her terminal 1 on the spot as described above, the system 3 or the terminal 31 of the filling station is notified of the contents of the credit card approval process of the purchaser such that money is transferred. Accordingly, since the purchaser does not need to give his/her credit card to the seller even in the card payment, the loss or illegal use of the card can be completely prevented.

The UC used in the embodiment of the present invention is in the form of a card manufactured by a card company (or a bank) and has seller information registered in or granted to the card company (or the bank) and inherent seller information which is externally used for the purpose of selling merchandise recorded therein.

### INDUSTRIAL APPLICABILITY

As described above, according to the present invention, the system includes a card company system which registers and grants UC information and issues an UC to a seller and requests a bank system to process credit card approval contents according to credit card approval information provided by a purchaser and to process the contents of the credit card approval process when the purchaser purchases merchandise through on- or off-line transaction, and a purchaser and seller terminal which allow the purchaser and the seller to access the bank system and the card company system through a wired/wireless communication line to perform the credit card approval process such that the personal information of the purchaser can be protected in electronic commercial transaction and a stable efficient credit card approval process is possible. Accordingly, illegal use of a customer's credit card and conflict between a purchaser and a seller can be prevented.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A selling system based on a purchaser using a new concept card, the system comprising:
a purchaser terminal which includes a function for accessing the Internet through a wired/wireless communication line and a function for accessing a seller server over the Internet, acquiring Ubiquitous card (UC) information, and purchasing merchandise, accesses a server of a card company to perform a credit card approval process after purchasing the merchandise, and accesses a bank system to perform a process relating a bank account;
a card system which registers, grants and issues UC information of a seller, identifies the purchaser, receives the UC information, credit card information, a purchase number and a price and performs the credit card approval process when the purchaser requests credit card approval, notifies the bank system of credit card approval contents of the purchaser to request transfer of money, stores card member information, the UC information of the purchaser and the seller, transaction information of the purchaser, and credit card approval information in a database (DB), and notifies the purchaser terminal and a seller system or a seller terminal of the card member information, the UC information of the purchaser and the seller, the transaction information of the purchaser, and the credit card approval information;
the bank system which stores card account information of the purchaser and the seller, manages the accounts by the purchaser terminal and the seller system or the seller terminal, and transfers money from the card account of the purchaser to the card account of the seller when the card system requests the processing of the credit card approval contents; and
the seller system which accesses a card company system over the Internet so as to register, grant, and issue the UC information, accesses the bank system to manage bank account information, provides information such that the purchaser can acquire the UC information and search and purchase the merchandise over the Internet, and includes a seller manager server for transmitting an order number and a price necessary for the credit card approval at the time of purchasing the merchandise and a seller terminal for connecting the seller to a card company or the purchaser.

2. The system according to claim 1, wherein the card system 4 comprises:
a card company server which controls the registration and grant of the UCs of the seller and the purchaser and the transfer of money from the card account of the purchaser to the card account of the seller;
a card company's web server which provides approval information to the card company server to perform the approval, when the purchaser inputs the purchase information the UC information of the purchaser over the Internet and requests the card company to transmit the credit card approval contents to the purchaser terminal and the seller system or the seller terminal;
a card company's ARS system which transmits a guide message such that a purchaser who accesses the card company server by a telephone can input transaction information and transmits the UC information and the transaction information of the purchaser to the card company server so as to perform the credit card approval process; and
a card company's mail server which transmits information as to whether transaction is accomplished or not to the purchaser terminal and the seller terminal.

3. A selling method based on a purchaser using a new concept card, the method comprising:
a first step of allowing a seller to enter into a affiliation contract using a seller terminal or through a visit to a card company, registering and granting a Ubiquitous card (UC) information, and issuing an UC;
a second step of allowing the seller to access a card company or a bank through a seller management server so as to register or grant the UC information and issue the UC, to access a bank system to manage bank account information, to access a purchaser terminal to perform a purchase process of the purchaser, and to notify the purchaser of information including the UC or all software and a module of the UC;
a third step of registering registration information of the UC of the seller obtained by the first and second steps in a database (DB) of the card company;
a fourth step of allowing the purchaser to access a seller system or the seller terminal using a purchaser terminal to receive the UC information, to have a consultation about the purchase of merchandise and to purchase the merchandise and allowing the seller to notify the purchaser terminal of requirements such as an order number and a price when the consultation about the purchase of the merchandise is completed;
a fifth step of allowing the purchaser to access the card company's ARS system and the card company's web server using the purchaser terminal to input credit card approval information such as the order number and the price or contact the UC so as to request credit card approval and to access the bank system to perform a process relating to a bank account, after the fourth step; and
a sixth step of allowing the card company's ARS system or the card company's web server to identify the purchaser through a predetermined authorization process while transmitting the credit card approval information inputted by the purchaser, and allowing the card company server to request transfer of money from a card account of the purchaser to a card account of the seller by the bank system after the authorization process; and
a seventh step of accessing the purchaser and the seller to process account management contents or accessing the card company or the bank to process credit card approval contents of the purchaser, which is requested by the card company.

4. The method according to claim 3, wherein the card company server notifies the purchaser terminal and the seller system and the seller terminal of the transaction result according to the credit card approval.

5. The method according to claim 3, wherein the card company server stores the transfer of money in the DB such that the seller is allowed to access the card company's web server and the card company's ARS system using the seller terminal to check whether transaction is accomplished according to the credit card approval.

6. The method according to claim 3, wherein the card company server processes credit card pre-approval in a card company's pre-approval DB when the credit card pre-approval of the purchaser occurs in the fifth step and performs an process of approving contents processed in the card company's pre-approval DB and requests the bank system to perform an approval process when purchased merchandise is delivered and main approval of the purchaser occurs.

7. The method according to claim 3, wherein, when the approval or the pre-approval of the purchaser occurs, the card company server performs an authorization process of the purchaser, transfers money to the card account of the seller, and demands money of the purchaser.

8. A selling system based on a purchaser using a new concept card which is registered or granted to a seller or an affiliated shop for registering related information in a card company or a bank, wherein basic information of the affiliated shop, such as a national code, a card identification code, an organ code, an affiliation year, a serial number, a verification number, and a company's serial number, a seller's name, a tax number, and a telephone number, a card number, and an inherent identification number are recorded in a form of numerals, characters, a barcode, and an electronic tag, and the card is in any one of a cash card form, a sticker form, a simple paper form, a terminal form, a system form, or an electronic tag form, which is used for identifying the seller affiliated with the card company.
